(19) United States
(12) Patent Application Publication
(10) Pub. No.: US 2020/0354636 A1
(43) Pub. Date: Nov. 12, 2020

(54) REMOVAL OF CATALYST FINES FROM FLUIDIZED BED EFFLUENT IN THE CONVERSION OF OXYGENATE FEEDSTOCK

(71) Applicant: ExxonMobil Research and Engineering Company, Annandale, NJ (US)

(72) Inventor: Suriyanarayanan Rajagopalan, Spring, TX (US)

(21) Appl. No.: 16/815,090

(22) Filed: Mar. 11, 2020

Related U.S. Application Data
(60) Provisional application No. 62/844,782, filed on May 8, 2019.

(51) Int. Cl. C10G 3/00; C10G 31/09; B01J 8/24; B01J 8/00

(52) U.S. Cl. CPC C10G 3/57; C10G 3/62; C10G 3/49; C10G 31/09; B01J 8/24; B01J 8/006; C10G 2300/4081; B01J 8/0075; C10G 2400/02; C10G 2400/20; C10G 2400/30; C10G 2300/4018; C10G 2300/706; B01J 8/0055

(57) ABSTRACT

A method comprising of converting an oxygenate feed stream stock to a hydrocarbon product stream having substantially no detectable solid content can include conveying the oxygenate feed stream stock through a fluidized catalyst bed comprising catalyst particles to convert the oxygenate feedstock to the product stream comprising catalyst particles and a hydrocarbon selected from the group consisting of a C₅₊ gasoline, an olefin, an aromatic, and combinations thereof; and conveying the product stream through a plurality of filter units comprising filter medium to generate a filtered product stream having substantially no detectable solid material, wherein the filter medium comprises a metal alloy, a sintered metal alloy, or a combination thereof.

### CROSS REFRENCE TO RELATED APPLICATIONS

This application claims the benefit of U.S. Provisional Application No. 62/844,782, filed on May 8, 2019, the entire contents of which are incorporated herein by reference.

### BACKGROUND OF THE INVENTION

This application relates to methods and systems for removing catalyst fines from a fluidized bed reactor effluent.

Processes for converting lower oxygenates (e.g., methanol and dimethyl ether (DME)) to hydrocarbons offer an attractive way of producing liquid hydrocarbon fuels, especially gasoline, from sources which are not petrochemical feeds. Specifically, lower oxygenates may be converted to gasoline fractions, olefins, and aromatics, the latter two of which are useful in the production of a variety of important chemicals and polymers.

Methanol and other lower oxygenates are typically converted to hydrocarbon products utilizing a fixed bed process, such as the processes described in U.S. Pat. Nos. 3,998,899; 3,931,349; and 4,035,430. Recently, technology has been developed for the use of a fluidized bed in converting methanol and lower oxygenates to gasoline, olefins, and aromatics. U.S. Pat. No. 9,938,205 discloses such processes. In both fixed bed processes and fluidized bed processes, an oxygenate feed stream is conveyed through a catalyst bed to convert molecules within a feed stream to a product stream comprising gasoline, olefins, and/or aromatics. One caveat when utilizing a fluidized catalyst bed is that the catalyst particles are not fixed in place (as is the case in a fixed catalyst bed). Thus, due to the velocity and force exerted by an oxygenate feed stream as it is conveyed through a fluidized catalyst bed, some of the catalyst particles, especially smaller particles, may be swept up by the product stream emerging from the catalyst bed. Systems for their removal exist and are employed, for example, cyclones. However, sufficient efficiency of catalyst removal is not achieved. For example, in U.S. Pat. No. 9,938,205, up to 50 mg/m³ of particulate matter were detected in the product stream after being conveyed through cyclone systems. This is problematic, especially in the production of gasoline, since federal regulations require gasoline to be free of any solid particulate matter.

Thus, there is a need to develop methods and systems for efficient and thorough removal of catalyst particles from a product stream derived from a fluidized catalyst bed.

### SUMMARY OF THE INVENTION

The application relates generally to removal of particles, in particular catalyst fines, from fluidized bed reactor effluent after conversion of an oxygenate feedstock to a hydrocarbon product (e.g., gasoline, olefins, and/or aromatics).

Provided herein are methods that include a method comprising: conveying an oxygenate feed stream stock through a fluidized catalyst bed comprising catalyst particles to convert the oxygenate feedstock to a product stream comprising catalyst particles and a hydrocarbon selected from the group consisting of a C₅₊ gasoline, an olefin, an aromatic, or a blend thereof; and conveying the product stream through a plurality of filter units comprising filter medium to generate a filtered product stream having substantially no detectable solid content, wherein the filter medium comprises a metal alloy, a sintered metal alloy, or a combination thereof.

Provided herein are systems that include a system comprising: an oxygenate feed stream; at least reactor comprising at least one fluidized catalyst bed comprising catalyst particles; a product stream comprising catalyst particles and a hydrocarbon selected from the group consisting of a C₅₊ gasoline, an olefin, an aromatic, or a blend thereof; a reactor inlet constructed and arranged to accept the oxygenate feed stream; and a plurality of filter units each comprising filter medium that comprises a metal alloy, a sintered metal alloy, or a combination thereof, wherein the plurality of filter units are fluidly connected to the at least one reactor and constructed and arranged to convey the product stream through said plurality of filter units to generate a filtered product stream comprising a hydrocarbon selected from the group consisting of a C₅₊ gasoline, an olefin, an aromatic, or a blend thereof further having substantially no detectable solid content.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 depicts an example embodiment of a catalyst filtration stage as disclosed herein utilizing filtration to remove catalyst particles from a fluidized bed effluent.

FIG. 2 depicts an example embodiment of a filter unit assembly as disclosed herein, which may be part of a catalyst filtration stage as disclosed herein utilizing filtration to remove catalyst particles from a fluidized bed effluent.

FIG. 3 depicts an example embodiment of a refinery system utilizing a conventional catalyst removal system followed by a catalyst filtration stage as disclosed herein utilizing filtration to remove catalyst particles from a fluidized bed effluent.

FIG. 4 an example embodiment of a refinery system utilizing a catalyst filtration stage as disclosed herein utilizing filtration to remove catalyst particles from a fluidized bed effluent.

FIG. 5 depicts an example embodiment of a refinery system utilizing a conventional catalyst removal system followed by a catalyst filtration separation stage as disclosed herein, wherein a fraction of the product stream is recycled back to the oxygenate feed stream.

### DETAILED DESCRIPTION

This application relates to systems, system components, and processes for converting a hydrocarbon stream comprising an oxygenate feedstock (e.g., methanol and DME) in a fluidized bed comprising a catalyst to a converted hydrocarbon stream comprising hydrocarbons (e.g., gasoline, olefins, and aromatics) and filtering the fluidized bed effluent comprising the converted hydrocarbon stream to remove any catalyst material therein.

Provided herein are systems, system components, and methods for converting an oxygenate feed stream to a product stream comprising less than 0.01% detectable particulate matter. A oxygenate feed stream may be conveyed through a fluidized catalyst bed under conditions sufficient to convert the oxygenate feed stream to a product stream. The product stream may be conveyed through at least one catalyst filtration separation stage to remove catalyst particles from the product stream sufficient to result in a product stream comprising less than 0.01% detectable particles.

Provided herein are methods that include a method comprising: conveying an oxygenate feed stream stock through a fluidized catalyst bed comprising catalyst particles to convert the oxygenate feedstock to a product stream comprising catalyst particles and a hydrocarbon selected from the group consisting of a C₅₊ gasoline, an olefin, an aromatic, or a blend thereof; and conveying the product stream through a plurality of filter units comprising filter medium to generate a filtered product stream having no detectable solid content.

Provided herein are systems that include a system comprising: an oxygenate feed stream; at least one reactor comprising at least one fluidized catalyst bed comprising catalyst particles; a product stream comprising catalyst particles and a hydrocarbon selected from the group consisting of a C₅₊ gasoline, an olefin, an aromatic, or a blend thereof; a reactor inlet constructed and arranged to accept the oxygenate feed stream; and a plurality of filter units each comprising filter medium, wherein the plurality of filter units are fluidly connected to the at least one reactor and constructed and arranged to convey the product stream through said plurality of filter units to generate a filtered product stream comprising a hydrocarbon selected from the group consisting of a C₅₊ gasoline, an olefin, an aromatic, or a blend thereof further having no detectable solid content.

### Catalyst Filtration Separation Stages

The systems and methods disclosed herein include a filtration-based system comprising filter medium. The filter medium has a pore size and a pore density sufficient to allow continuous passage of a product stream through the filter medium to emerge in a catalyst filtration stage effluent as a filtered product stream. Additionally, the filter medium has a pore size and density sufficient to stop and/or trap any particles smaller than about 20 μm (e.g., about 10 nm to about 20 μm) from being conveyed through the filter medium. For example, suitable filter medium may be characterized by a pore size of less than about 20 μm, including less than about 15 μm, less than about 10 μm, less than about 5 μm, less than about 2 μm, less than about 1 μm, less than about 0.2 μm, or less than about 0.1 μm. Pore size of filter medium may be measured, for example, according to ASTM E-128(2011).

A catalyst filtration stage comprises at least one filter assembly unit, the at least one filter assembly unit comprising a plurality of filter units. Each filter unit comprises filter medium. Each of the plurality of filter units may be constructed having one or more outer surfaces defining a three-dimensional shape. A product stream may enter a filter unit through any of the outer surfaces and be conveyed inward towards the center of the filter unit. A filter unit may have a central void through which a filtered product stream may be conveyed upward for transport of the resulting filtered product stream to a subsequent system component (e.g., separation). In any embodiment, the pores of the filter medium at the filter unit surface may be denser than the pores of the filter medium towards the center of the filter unit, for example, in a gradient where filter medium pores are smallest at the filter unit surface and largest at the interface of the filter medium and the central void of the filter unit.

As a product stream comprising catalyst particles is continuously conveyed through the filter medium, catalyst particles may accumulate on the surface at the interface (i.e., the outer surface of a filter unit) where the product stream enters the filter medium of a filter unit. Over time, the accumulation of catalyst particles may hinder the flow of the product stream. Thus, a catalyst filtration stage may additionally comprise a mechanism for removing accumulated particulate matter on an outer surface of a filter unit.

A mechanism for removing accumulated particles may comprise, for example, a source of blowback gas, which is fluidly connected one or more filter units such that blowback gas may be conveyed through the filter medium in a direction countercurrent to the direction in which the product stream is conveyed during normal operation (i.e., when converting oxygenate feedstock). Thus, accumulated catalyst particles may be dislodged by force exerted on the catalyst particles by the blowback gas stream. A system may further comprise a catalyst collection stage where catalyst particles may be collected and conveyed for reuse into a fluidized catalyst bed.

In any embodiment, catalyst particles may accumulate on the outer surface of a filter unit in the form of a permanent layer and a nonpermanent layer. The extent of accumulation of catalyst particles on the outer surface of a filter unit may be monitored, for example, by measuring the pressure differential across each filter assembly. A pressure threshold may be set such that pressure exceeding an upper pressure limit will automatically engage the flow of blowback gas through the filter assembly and through each filter unit. Measuring pressure differential may additionally aid in the detection of leaks (that is, the possibility that a catalyst particle would not be trapped but rather be conveyed through a filter unit and remain in the product stream). A pressure threshold may be set such that pressure exceeding a lower pressure limit may automatically engage a filter plug to stop any material from entering the one or more filter units or the whole filter assembly, effectively plugging the “leak.”

Additionally or alternatively, engagement of a system to initiate flow of blowback gas through a filter assembly may be set to occur periodically, (e.g., every hour). The duration of the flow of blowback gas may range anywhere from a short pulse, for example, less than about 5 seconds, less than about 3 seconds, or less than about 2 seconds to many hours, for example, about 1 hour, about 2 hours, about 3 hours, about 4 hours, or more than about 4 hours.

The blowback gas may be, for example, an inert gas such as nitrogen or a light hydrocarbon gas, such as natural gas. A blowback gas stream may be conveyed through a filter assembly at a pressure greater than the normal operating pressure of the filter assembly. For example, a blowback gas stream may be operated at 1.8 to twice the operating pressure of a filter unit or filter assembly.

The filter medium may be resistant to degradation and changes in filtering efficiency in extreme environments, for example in high-temperature, high pressure, or highly corrosive environments. For example, the filter medium may be able to withstand constant temperatures up to 540° C., temperatures of up to 650° C. for short periods, and a differential pressure in excess of 6.89 MPa.

The material from which a filter medium may be manufactured may be dictated by operating conditions of the filter unit as different materials are differentially affected by temperature, pressure, acid content, and the like. For example, the filter medium may be a metal alloy, a sintered metal alloy, or a combination thereof. Examples of filter medium may include but are not limited to, a stainless steel alloy, for example, an alloy of two or more of molybdenum, nickel, copper, manganese, chromium, iron, cobalt, and silicon. Suitable alloys may additionally comprise carbon, silicon, or both.

In any embodiment, the filter medium may be in the form of a fiber, a powder, or a combination thereof. For example, a metal fiber may have a diameter of about 1.5 microns to about 80 microns. Metal fibers may be bonded to each other, for example, through sintering, to avoid use of additional binder. In any embodiment, the filter medium may comprise no binder or may be absent binder. This may be particularly beneficial, for example, as binders could conceivably break free and enter a product stream. Metal filter medium may be loaded into a filter unit, for example, by centrifugal casting.

The filter medium may be capable of removing any solid material from a fluidized catalyst bed effluent. In particular, a filter unit as described herein may efficiently and effectively remove solids that are less than 20 μm in diameter (e.g., about 10 nm to about 20 μm).

By utilizing a catalyst filtration stage as described above, substantially 100 wt. % of catalyst particles present in a fluidized catalyst bed effluent (comprising a product stream) may be removed. As used herein, substantially 100 wt. % means greater than about 99.9 wt. %, which includes about 99.90 wt. %, about 99.95 wt. %, about 99.99 wt. %, or higher than about 99.99 wt. %. Accordingly, the filtered product stream may comprise substantially no detectable solid content, where substantially no detectable solid content refers to having about 0.1 wt. % or less (including 0 wt.%) solid content.

This may be accomplished by constructing porous medium within a filter unit in a manner that effectively blocks solids from being conveyed through the filter medium and utilization of a system to detect and automatically plug leaks. In any embodiment, a filtered product stream derived from such a system comprises no detectable solid content (i.e., 100 wt. % of solids removed by the catalyst filtration stage). For example, a filtered product stream may comprise substantially no detectable solid content.

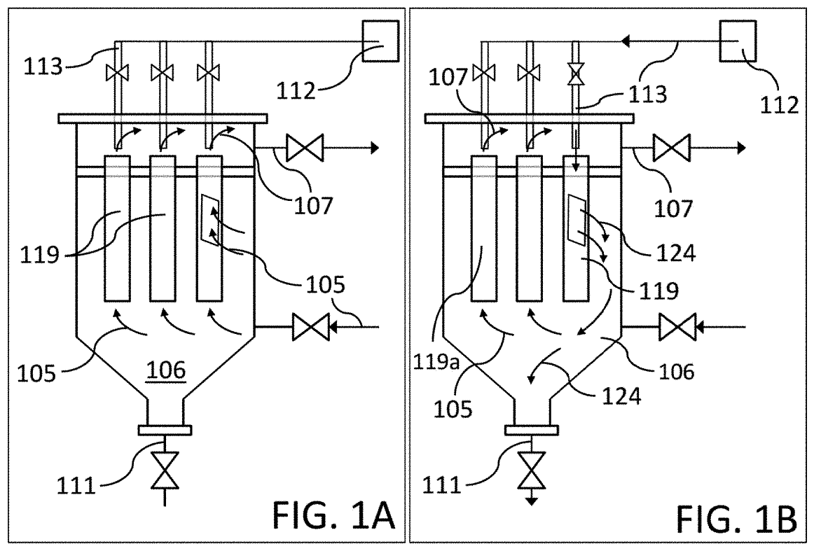

FIG. 1A depicts an example embodiment of a catalyst filtration stage comprising filter units as described above. In FIG. 1A, the catalyst filtration stage 106 includes a separation stage affluent 105 comprising a product stream which is conveyed through at least two filter units 119, exiting as a catalyst filtration stage 107 effluent comprising a filtered product stream. Catalyst filtration stage 106 includes two or more conduits 113, each for conveying blowback gas from a blowback gas source 112 through each of the two or more filter units 119. Catalyst particles may be collected via a catalyst collection stream 111 at the bottom of the catalyst filtration stage 106.

FIG. 1B, where like numbers represent like components, illustrates the example embodiment of FIG. 1A where blowback gas is being conveyed in a countercurrent direction (with respect to the product stream) through filter unit 119. Blowback gas source 112 conveys blowback gas through a conduit 113 then through a filter unit 119. Catalyst accumulated on the outer surface of filter unit 119 is dislodged and transported with the blowback gas stream 124 and collected via a catalyst collection stream 111. Notably, blowback gas may be conveyed through a filter unit 119 at the same time separation stage affluent 105 continues to enter the catalyst filtration stage 106 and pass through other filter unit/s 119a. Thus, a catalyst filtration stage configured such as the one depicted in FIGS. 1A and 1B may remain online for continuous filtration of a product stream.

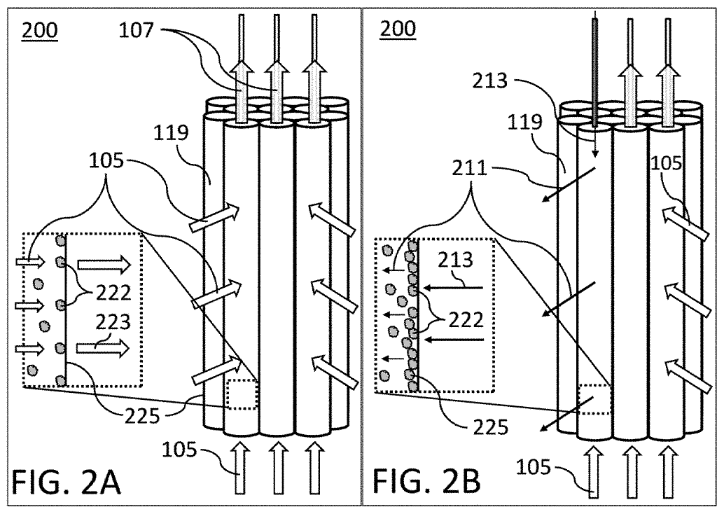

FIG. 2A, where like numbers from FIGS. 1A and 1B represent like components, depicts an example configuration of filter units into a filter assembly 200. Separation stage affluent 105 is conveyed through the outer surface 225 of the filter unit 119 towards the center as a filtered product stream 223, exiting the filter unit 119 as a catalyst filtration stage effluent 107 comprising a filtered product stream. Catalyst particles 222 in the separation stage affluent 105 are prevented from passing through the outer surface 225 of a filter unit 119.

FIG. 2B, where like numbers represent like components, illustrates the example embodiment of FIG. 2A where a blowback gas stream 213 is conveyed in a countercurrent direction (with respect to the product stream) through filter unit 119. Catalyst particles 222 accumulated on the outer surface 225 of the filter unit 119 are dislodged by the blowback gas stream 213.

### Refinery Systems for Converting Oxygenate Feed Streams

The one or more catalyst filtration stages described above may be suitable for use in a refinery setting, for example, in the preparation of product streams comprising gasoline. For example, a catalyst filtration stage may be implemented to filter a product stream derived from the conversion of oxygenate feed streams to a product stream comprising a hydrocarbon selected from the group consisting of a C₅₊ gasoline, an olefin, an aromatic, or a blend thereof.

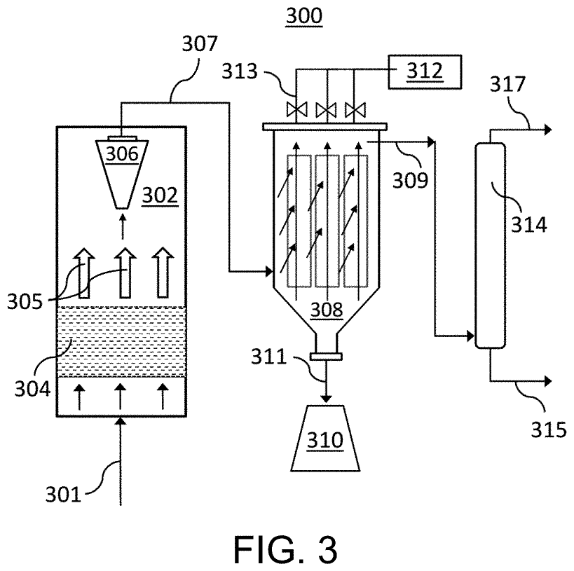

FIG. 3 depicts an example refinery system 300 suitable for carrying out methods disclosed herein. The refinery system 300 includes a reactor 302 having a fluidized catalyst bed 304, a first catalyst separation system 306, a second catalyst separation system 308, and a product stream separation stage 314. The second catalyst separation system 308 is a filtration system as described above, having a source of blowback gas 312, conduits 313 for conveying the blowback gas to each filter unit, and a catalyst collection stage 310 where the catalyst collection stream 311 may be conveyed. An oxygenate feed stream 301 may be conveyed into reactor 302 through a fluidized catalyst bed 304. The fluidized catalyst bed effluent 305 comprising a product stream and catalyst particles may be conveyed through a first catalyst separation stage 306. The effluent of the first catalyst separation stage 307 may still contain some catalyst particles, for example, catalyst fines having a particle size equal to or less than 20 μm (e.g., about 10 nm to about 20 μm). Thus, first catalyst separation stage effluent 307 may be conveyed to a catalyst filtration stage 308 to remove the remaining catalyst particles. The effluent of the catalyst filtration stage 309 comprises a filtered product stream which may be conveyed to a product stream separation stage 314, which may separation the product stream into two or more fractions 315, 317, such as, but not limited to, C₅₊ gasoline, an olefin fraction, an aromatic fraction, or a blend thereof.

The first catalyst separation stage 306 may be any apparatus or mechanism routinely used in the art, for example, one or more cyclones, one or more baghouses, one or more electrostatic precipitators, one or more scrubbers, or any combination thereof.

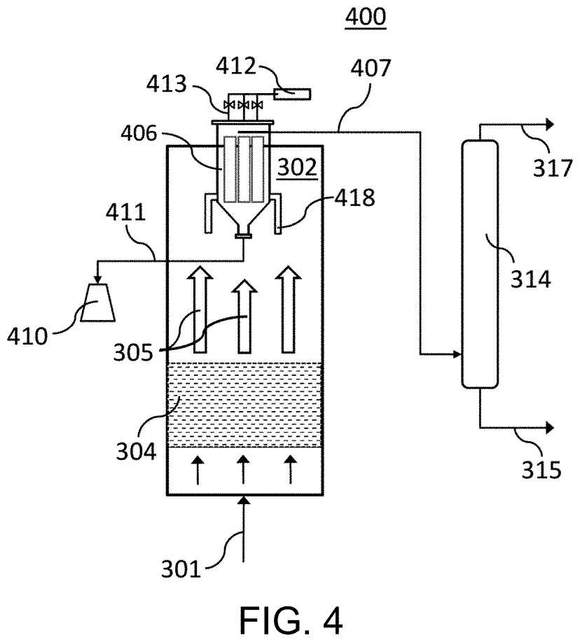

FIG. 3 depicts a refinery system comprising a first catalyst separation stage 306 upstream of a catalyst filtration stage 308. However, in any embodiment, a refinery system may comprise only a catalyst filtration stage. FIG. 4 depicts such a refinery system, where like numbered components are the same as described in FIG. 3. In FIG. 4, the catalyst filtration stage 406 is similar to the catalyst filtration stage 308 depicted in FIG. 3, but is fed directly by the fluidized catalyst bed effluent 305. The catalyst filtration stage 406 has one or more inlets to accept the fluidized catalyst bed effluent 305 a conduit to convey the resulting filtered product stream 407 to a separation stage 314. The catalyst filtration stage 406 additionally is connected through one or more conduits 413 to a source of blowback gas 412. Catalyst particles may be collected through a catalyst collection stream 411 feeding into a catalyst collection stage 410.

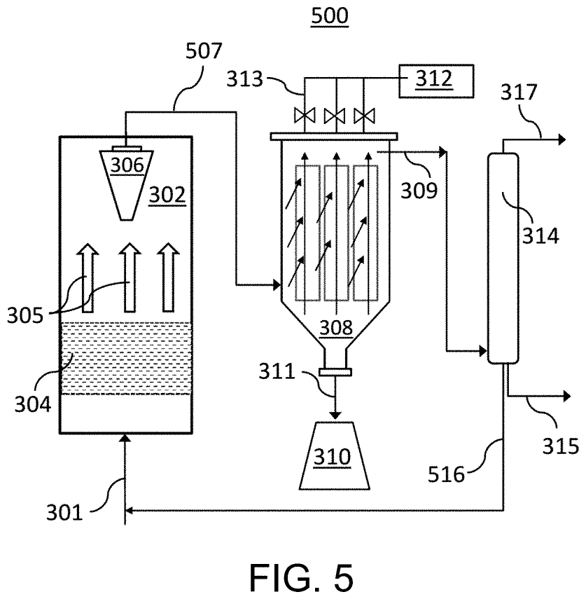

In any embodiment, a product stream may be separated into a fraction, for example, a C₄₋ fraction, that may be recycled back to the reactor. FIG. 5, where like numbers represent like components as FIG. 3, depicts such a system. At the product stream separation stage 314, a fraction 516 may be isolated and conveyed back to and combined with the oxygenate feed stream 301 and be conveyed through refinery system 500 again.

In any embodiment, a refinery system may comprise one or more heaters or heat exchangers to warm an oxygenate stream to an appropriate temperature for introduction into a reactor. In any embodiment, a refinery system may comprise additional reactors, each comprising a catalyst bed. Catalyst beds in additional reactors may be fluidized catalyst beds or fixed catalyst beds. Optionally, any reactor may include two or more catalyst beds (e.g., a stacked bed).

The conversion of methanol and/or DME to a product stream as described herein is highly exothermic. For example, the conversion releases approximately 750 BTU of heat per pound of methanol. Thus, in any embodiment, a system may also include a component to cool a fluidized bed reactor. A fluidized bed reactor may be internally cooled or externally cooled. For example, a fluidized bed reactor that is internally cooled may include a heat exchanger in one or more stages. Use of internal heat exchangers is disclosed, for example, in U.S. Pat. No. 9,928,305, which is incorporated herein by reference. In another example, an externally cooled fluidized bed reactor may include a catalyst cooler for removing heat from a fluidized bed reactor by circulating catalyst between a fluidized bed reactor and a catalyst cooler. Use of catalyst cooler is disclosed, for example, in U.S. Pat. No. 9,928,305, which is incorporated herein by reference with respect to operating and configuration of catalyst coolers. I

n any embodiment, a product stream separation stage may carry out one or more separations to isolate desired fractions from a product stream. For example, a product stream separation stage may comprise a cooler to condense water in the product stream for subsequent removal. A product stream separation stage may comprise one or more stabilizers or one or more dividing wall columns, such that a C₄₋ light gas fraction may be separated from C₅₊ gasoline. A C₄₋ light gas fraction may be conveyed to a de-ethanizer fractionating column, where a C₂₋ light gas fraction may be separated from LPG (a hydrocarbon composition comprising propane, n-butane, and isobutane). Optionally, to improve C₅₊ gasoline yield, an alkylation unit may optionally be included to convert isobutene, propylene, butenes, or any combination thereof, to C₅₊ gasoline. For example, C₃ and C₄ gases separated from C₅₊ gasoline in a filtered product stream may be sent to an alkylation unit to convert isobutene, propylene, and butenes to C₅₊ gasoline.

In any embodiment, a refinery system may include components for catalyst regeneration. Carbonaceous material (coke) may be formed on the catalyst surface during the conversion process, blocking active sites for the conversion and leading to catalyst deactivation. Coked catalysts from a fluidized bed reactor may be transferred to a regenerator to burn accumulated coke off the catalyst surface. Regenerated catalyst may then be transferred back to the fluidized bed reactor.

In each figure provided herein, a solid line with an arrowhead connecting two components represents a conduit that fluidly connects those components. Neither solid lines nor components are drawn to scale. Solid lines contain arrowheads, which indicate flow direction of material within the depicted conduit during normal operation (i.e., when converting oxygenate feedstock). While not explicitly illustrated in any figure, each component may include additional equipment that allows for control of the various components, for example, flow rate, temperature, pressure, and the like. Conduits may also include, for example, valves, to allow control and redirection of fluid and/or gas flow through the system.

### Methods for Converting Oxygenate Feed Streams

The systems disclosed herein may be suitable for converting an oxygenate feed stream to a product stream comprising less than about 0.01 wt. % detectable particulate matter. A oxygenate feed stream may be conveyed through a fluidized catalyst bed under reaction conditions sufficient to convert the oxygenate feed stream to a product stream. For example, the reaction conditions to convert the oxygenate feed stream stock to the product stream may include a temperature of about 260° C. to about 540° C., a pressure of about 17 kPa to about 2 MPa, an weight hourly space velocity (WHSV) of about 0.1 hours⁻¹ to about 20 hours⁻¹, and any combination thereof.

The product stream may be conveyed through at least one catalyst filtration stage to remove catalyst particles from the product stream sufficient to result in a product stream comprising less than 0.01% detectable particles.

### Oxygenate Feed Streams

Suitable feed streams for the systems and methods disclosed herein include oxygenate feed streams. As used herein, the term “oxygenate” refers to oxygen-containing compounds having one to about twenty carbon atoms, one to about ten carbon atoms, or one to about four carbon atoms. Examples of oxygenates include alcohols, ethers, carbonyl compounds (e.g., aldehydes, ketones and carboxylic acids), and mixtures thereof. Non-limiting examples of oxygenates include methanol, ethanol, dimethyl ether, diethyl ether, methyl ethyl ether, di-isopropyl ether, dimethyl carbonate, dimethyl ketone, formaldehyde, acetic acid, the like, and combinations thereof. For example, in any embodiment, an oxygenate feedstock may comprise methanol, DME, or a mixture thereof.

Methanol may be obtained from coal, natural gas, biomass, or any combination thereof, by conventional processes. In a methanol to gasoline conversion process, methanol may be used as a direct feedstock or may first be dehydrated to form dimethyl ether.

### Reactors and Fluidized Catalyst Beds

The systems and methods disclosed herein for converting an oxygenate feed stream may include at least one reactor and at least one fluidized catalyst bed.

The reactor may be operated at any temperature known to one of skill in the art for efficient conversion of oxygenate feed streams to a product stream comprising a hydrocarbon selected from the group consisting of a C₅₊ gasoline, an olefin, an aromatic, or a blend thereof. For example, a reactor may be operated at a temperature of about 260° C. to about 540° C. A reactor may be operated at any pressure known to one of skill in the art resulting in efficient conversion of an oxygenate feed stream to a product stream comprising a hydrocarbon selected from the group consisting of a C₅₊ gasoline, an olefin, an aromatic, or a blend thereof. For example, a reactor may be operated at a pressure of about 17 kPa to about 2 MPa. A reactor may be operated at any weight hourly space velocity (WHSV) or liquid hourly space velocity (LHSV) known to one of skill in the art resulting in efficient conversion of an oxygenate feed stream to a product stream comprising a hydrocarbon selected from the group consisting of a C₅₊ gasoline, an olefin, an aromatic, or a blend thereof. For example, a reactor may be operated at a WHSV from about 0.1 hours⁻¹ to about 20 hours⁻¹.

The systems described herein include at least one reactor having at least one fluidized catalyst bed comprising at least one catalyst capable of catalyzing the conversion of methanol and/or DME to a hydrocarbon selected from the group consisting of a C₅₊ gasoline, an olefin, an aromatic, or a blend thereof.

Useful catalysts are described in detail in U.S. Pat. No. 9,928,305, which is incorporated herein by reference with respect to its disclosure of suitable catalysts for methanol-to-gasoline conversion. A suitable catalyst may include a zeolite. As used herein, “zeolite” or “zeolitic” refers to a crystalline material having a porous framework structure built from tetrahedral atoms connected by bridging oxygen atoms. Examples of known zeolite frameworks are given in the “Atlas of Zeolite Frameworks” published on behalf of the Structure Commission of the International Zeolite Association”, 6^{th} revised edition, Ch. Baerlocher, L. B. McCusker, D. H. Olson, eds., Elsevier, N.Y. (2007) and the corresponding web site, http://www.iza-structure.org/databases, each which is incorporated by reference herein with respect to its disclosure of zeolitic frameworks and methods for their preparation. Under this definition, a zeolite can refer to aluminosilicates having a zeolitic framework type as well as crystalline structures containing oxides of heteroatoms different from silicon and aluminum. Such heteroatoms can include any heteroatom generally known to be suitable for inclusion in a zeolitic framework, such as gallium, boron, germanium, phosphorus, zinc, antimony, tin, and/or other transition metals that can substitute for silicon and/or aluminum in a zeolitic framework. A zeolite may be referred to by the number of tetrahedral atoms (exclusive of oxygen atoms) that define pore openings in the zeolite's structure. For example, a zeolite may be an 8-member ring zeolite, a 10-member ring zeolite, or a 12-member ring zeolite.

### Product Streams

An oxygenate feed stream may be converted into a product stream comprising one or more olefins, one or more aromatics, one or more C₅₊ gasoline hydrocarbons, a C₄₋ fraction, a C₂₋ fraction, or a blend thereof. As used herein, the terms “C₅₊ gasoline,” and grammatical variations thereof, refers to a hydrocarbon composition characterized by one or more of having from five to twelve carbon atoms and has a boiling range characterized by a T₅-T₉₅ range of about 100° F. (38° C.) to about 400° F. (204° C.). A product stream may comprise a C₅₊ gasoline yield of at least about 65 wt. %, at least about 75 wt. %, at least about 80 wt. %, at least about 90 wt. %, or at least about 95 wt. %, based on the weight of the oxygenate feed stream. Methods for improving yield are disclosed in U.S. Pat. No. 9,928,305, which is incorporated herein by reference with respect to said disclosed methods.

As used herein, the terms “C₄₋ light gas,” and grammatical variations thereof, refers to a composition comprising hydrocarbons having one, two, three, or four carbon atoms. As used herein, the terms “C₂₋ light gas,” and grammatical variations thereof, refers to a composition that comprises hydrocarbons having one or two carbon atoms.

As used herein, the term “olefin,” alternatively referred to as “alkene,” refers to an unsaturated hydrocarbon chain of two to about twelve carbon atoms in length containing at least one carbon-to-carbon double bond. An olefin may be straight chain or branched chain. Non-limiting examples include ethylene, propylene, butylene, and pentene. “Olefin” is intended to embrace all structural isomeric forms of olefins.

As used herein, and unless otherwise specified, the term “aromatic” and grammatical variations thereof, refers to unsaturated cyclic hydrocarbons having a delocalized conjugated pi-system and having from six to thirty carbon atoms (e.g., aromatic C₆-C₃₀ hydrocarbon). Examples of aromatics include, but are not limited to, benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. An aromatic may comprise one or more heteroatoms. Examples of heteroatoms include, but are not limited to, nitrogen, oxygen, and/or sulfur. Aromatics with one or more heteroatom include, but are not limited to, thiophene, benzothiophene, oxazole, thiazole and the like, and combinations thereof. An aromatic may comprise monocyclic, bicyclic, tricyclic, and/or polycyclic rings (in any embodiment, at least monocyclic rings, only monocyclic and bicyclic rings, or only monocyclic rings) and may be fused rings.

### Example Embodiments

One nonlimiting example embodiment is a method comprising conveying an oxygenate feed stream stock through a fluidized catalyst bed comprising catalyst particles to convert the oxygenate feedstock to a product stream comprising catalyst particles and a hydrocarbon selected from the group consisting of a C₅₊ gasoline, an olefin, an aromatic, and combinations thereof; and conveying the product stream through a plurality of filter units comprising filter medium to generate a filtered product stream having substantially no detectable solid material (e.g., no detectable solid material). Optionally, the embodiment can further include one or more of the following: Element 1: the method further comprising separating the filtered product stream into one or more of a C₅₊ gasoline fraction, a C₄₋ fraction, a liquid petroleum gas fraction, an aromatic fraction, an olefin fraction, and an C₂-C₄ olefin fraction; Element 2: Element 1 and further combining the C₄₋ fraction with the oxygenate feed stream; Element 3: the method wherein the filter medium comprises a metal alloy; Element 4: the method wherein the filter medium comprises a sintered metal alloy; Element 5: the method wherein the filter medium comprises no binder; Element 6: the method further comprising conveying a source of blowback gas through one or more filter units in a direction countercurrent to the flow of the oxygenate feed stream; Element 7: Element 6 and wherein the blowback gas comprises a C₄₋ hydrocarbon or an inert gas; Element 8: the method further comprising monitoring the pressure differential across one or more filter units; Element 9: Element 8 and wherein when the pressure differential decreases below a pre-selected threshold, a plug is engaged to prevent flow of the oxygenate feed stream through one or more of the filter units; Element 10: Element 8 and wherein when the pressure differential surpasses a pre-selected limit, blowback gas is conveyed through one or more filter units in a direction countercurrent to the flow of the oxygenate feed stream; Element 11: the method wherein the one or more catalyst particles comprise a zeolite; Element 12: the method further comprising collecting the catalyst particles dislodged from the one or more outer surfaces of each filter and conveying them to a catalyst bed; Element 13: the method wherein reaction conditions to convert the oxygenate feed stream stock to the product stream comprise one or more of a temperature of about 260° C. to about 540° C., a pressure of about 17 kPa to about 2 MPa, and an WHSV of about 0.1 hours⁻¹ to about 20 hours⁻¹; the method wherein the oxygenate feed stream comprises methanol, dimethyl ether, or a blend thereof; Element 14: the method further comprising alkylating C₃ and C₄ gasses in the filtered product stream to produce C₅₊ gasoline; and Element 15: the method further comprising conveying the product stream through a catalyst separation stage comprising at least one of a cyclone, baghouse, electrostatic precipitator, or scrubber prior to conveying the product stream through a plurality of filter units comprising filter medium to generate a filtered product stream having no detectable solid content. Examples of combinations include, but are not limited to, Element 1 (and optionally Element 2) in combination with one or more of Elements 3-15; Element 3 in combination with one or more of Elements 4-15; Element 4 in combination with one or more of Elements 5-15; Element 5 in combination with one or more of Elements 6-15; Element 6 (and optionally Element 7) in combination with one or more of Elements 8-15; Element 8 (and optionally Element 9, Element 10, or both) in combination with one or more of Elements 11-15; Element 11 in combination with one or more of Elements 12-15; Element 12 in combination with one or more of Elements 13-15; Element 13 in combination with one or more of Elements 14-15; Element 14 in combination with Element 15; Element 4 in combination with Element 5; Element 4 in combination with Element 5 and Element 6; and Element 4 in combination with Element 5, Element 6, and Element 8.

Another nonlimiting example embodiment is a system comprising an oxygenate feed stream; at least one reactor comprising at least one fluidized catalyst bed comprising catalyst particles; a product stream comprising catalyst particles and a hydrocarbon consisting of a C₅₊ gasoline, an olefin, an aromatic, and combinations thereof; a reactor inlet constructed and arranged to accept the oxygenate feed stream; and a plurality of filter units each comprising filter medium, wherein the plurality of filter units are fluidly connected to the at least one reactor and constructed and arranged to convey the product stream through said plurality of filter units to generate a filtered product stream comprising a hydrocarbon selected from the group consisting of a C₅₊ gasoline, an olefin, and an aromatic further having substantially no detectable solid material (e.g., no detectable solid material). Optionally, the embodiment can further include one or more of the following: Element 16: the system wherein the filter medium comprises a metal alloy; Element 17: the system wherein the filter medium comprises a sintered metal alloy; Element 18: the system wherein the filter medium comprises no binder; Element 19: the system the catalyst filtration separation system comprises a source of blowback gas fluidly connected to one or more of the plurality of filter units and arranged to convey blowback gas through one or more of the plurality of filter units in a direction countercurrent to the flow of the oxygenate feed stream; Element 20: Element 19 and wherein the blowback gas comprises a C₄₋ hydrocarbon or an inert gas; Element 21: the system wherein the system is further configured to measure the pressure differential across one or more of the filter units; Element 22: Element 21 and wherein when the pressure differential decreases below a pre-selected threshold, a plug is engaged to prevent flow of the oxygenate feed stream through one or more of the filter units; Element 23: Element 21 and wherein when the pressure differential surpasses a pre-selected limit, blowback gas is conveyed through one or more filter units in a direction countercurrent to the flow of the oxygenate feed stream; Element 24: the system wherein the one or more catalyst particles comprise a zeolite; Element 25: the system further comprising collecting the catalyst particles dislodged from the one or more outer surfaces of each filter and conveying them to a catalyst bed; Element 26: the system wherein the oxygenate feed stream comprises methanol, dimethyl ether, or a blend thereof; Element 27: the system further comprising one or more of a cyclone, baghouse, electrostatic precipitator, or scrubber. Examples of combinations include, but are not limited to, Element 16 in combination with one or more of Elements 17-27; Element 17 in combination with one or more of Elements 18-27; Element 18 in combination with one or more of Elements 19-27; Element 19 (and optionally Element 20) in combination with one or more of Elements 21-27; Element 21 (and optionally Element 22, Element 23, or both) in combination with one or more of Elements 24-27; Element 24 in combination with one or more of Elements 25-27; Element 25 in combination with one or more of Element 26 and Element 27; Element 26 in combination with Element 27; Element 17 in combination with Element 18; Element 17 in combination with Elements 18 and 19; and Element 17 in combination with Element 18, Element 19, and Element 21.

Unless otherwise indicated, all numbers expressing quantities of ingredients, properties, such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods may also “consist essentially of” or “consist of” the various components and steps.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods may also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about “a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
conveying an oxygenate feed stream stock through a fluidized catalyst bed comprising catalyst particles to convert the oxygenate feedstock to a product stream comprising catalyst particles and a hydrocarbon selected from the group consisting of a C₅₊ gasoline, an olefin, an aromatic, and combinations thereof; and
conveying the product stream through a plurality of filter units comprising a filter medium to generate a filtered product stream having substantially no detectable solid material, wherein the filter medium comprises a metal alloy, a sintered metal alloy, or a combination thereof.

2. The method of claim 1, wherein the product stream comprises no detectable solid material.

3. The method of claim 1, further comprising separating the filtered product stream into one or more of a C₅₊ gasoline fraction, a C₄₋ fraction, an liquid petroleum gas fraction, an aromatics fraction, an olefin fraction, and a C₂-C₄ olefin fraction.

4. The method of claim 3, further combining the C₄₋ fraction with the oxygenate feed stream.

5. The method of claim 1, further comprising alkylating C₃ and C₄ gasses in the filtered product stream to produce C₅₊ gasoline.

6. The method of claim 1, wherein the filter medium comprises no binder.

7. The method of claim 1, the method further comprising conveying a source of blowback gas through one or more filter units in a direction countercurrent to the flow of the oxygenate feed stream.

8. The method of claim 7, wherein the blowback gas comprises a C₄₋ hydrocarbon or an inert gas.

9. The method of claim 1, further comprising monitoring the pressure differential across one or more filter units.

10. The method of claim 9, wherein when the pressure differential decreases below a pre-selected threshold, a plug is engaged to prevent flow of the oxygenate feed stream through one or more of the filter units.

11. The method of claim 9, wherein when the pressure differential surpasses a pre-selected limit, blowback gas is conveyed through one or more filter units in a direction countercurrent to the flow of the oxygenate feed stream.

12. The method claim 1, wherein one or more catalyst particles comprise a zeolite.

13. The method of claim 1, further comprising collecting the catalyst particles dislodged from the one or more outer surfaces of each filter and conveying them to a catalyst bed.

14. The method of claim 1, further comprising conveying the product stream through a catalyst separation stage comprising at least one of a cyclone, baghouse, electrostatic precipitator, or scrubber prior to conveying the product stream through a plurality of filter units comprising filter medium to generate a filtered product stream having substantially no detectable solid content.

15. The method of claim 1, wherein the oxygenate feed stream comprises methanol, dimethyl ether, or a blend thereof.

16. The method of any claim 1, wherein reaction conditions to convert the oxygenate feed stream stock to the product stream comprise one or more of a temperature of about 260° C. to about 540° C., a pressure of about 17 kPa to about 2 MPa, and an weight hourly space velocity (WHSV) of about 0.1 hours⁻¹ to about 20 hours⁻¹.

17. A system comprising:
an oxygenate feed stream;
at least one reactor comprising at least one fluidized catalyst bed comprising catalyst particles;
a product stream comprising catalyst particles and a hydrocarbon consisting of a C₅₊ gasoline, an olefin, an aromatic, and combinations thereof;
a reactor inlet constructed and arranged to accept the oxygenate feed stream; and
a plurality of filter units each comprising filter medium that comprises a metal alloy, a sintered metal alloy, or a combination thereof,
wherein the plurality of filter units are fluidly connected to the at least one reactor and constructed and arranged to convey the product stream through said plurality of filter units to generate a filtered product stream comprising a hydrocarbon selected from the group consisting of a C₅₊ gasoline, an olefin, an aromatic, and combinations thereof, further having substantially no detectable solid material.

18. The system of claim 17, wherein the product stream comprises no detectable solid material.

19. The system of claim 17, wherein the filter medium comprises no binder.

20. The system of claim 17, wherein the catalyst filtration separation system comprises a source of blowback gas fluidly connected to one or more of the plurality of filter units and arranged to convey blowback gas through one or more of the plurality of filter units in a direction countercurrent to the flow of the oxygenate feed stream.

21. The system of claim 17, wherein the system is further configured to measure the pressure differential across one or more of the filter units.

22. The system of claim 17, further comprising one or more of a cyclone, baghouse, electrostatic precipitator, or scrubber.
